(19) United States
(12) Patent Application Publication
(10) Pub. No.: US 2023/0298578 A1
(43) Pub. Date: Sep. 21, 2023

(54) DYNAMIC THRESHOLD FOR WAKING UP DIGITAL ASSISTANT

(71) Applicant: Lenovo (Singapore) Pet. Ltd., Singapore (SG)

(72) Inventors: Mark Delaney, Raleigh, NC (US); Nathan Peterson, Oxford, NC (US); John C. Mese, Cary, NC (US); Arnold Weksler, Raleigh, NC (US); Russell Speight VanBlon, Raleigh, NC (US)

(21) Appl. No.: 17/697,439

(22) Filed: Mar. 17, 2022

(51) Int. Cl. G10L 15/187; G10L 15/22; G10L 15/18; G06V 40/16; G06F 40/30

(52) U.S. Cl. CPC G10L 15/187; G10L 15/22; G10L 15/1815; G06V 40/172; G06F 40/30; G10L 2015/088

(57) ABSTRACT

In one aspect, a device may include a processor and storage accessible to the processor. The storage may include instructions executable to access data and determine, in a first instance and based on the data, a dynamic threshold for invoking a digital assistant via a wake-up word. The instructions may also be executable to identify, in the first instance, audible input evoking use of the wake-up word. Based on the dynamic threshold being met in the first instance, the instructions may be executable to invoke the digital assistant in response to identifying the audible input.

### FIELD

The disclosure below relates to technically inventive, non-routine solutions that are necessarily rooted in computer technology and that produce concrete technical improvements. In particular, the disclosure below relates to dynamic thresholds for waking up a digital assistant.

### BACKGROUND

Electronic digital assistants are being integrated into more and more devices. As recognized herein, with their increased prevalence comes increased unintentional triggers of the digital assistant. As further recognized herein, this can lead not only to annoying and unnecessary interactions with the digital assistant but also to data security issues as confidential information unintentionally captured by the digital assistant may be streamed and stored offsite, exposing a technological shortcoming of these devices in terms of processing and security. And at the very least, processor resources will be unnecessarily consumed along with RAM and battery power due to the false triggers, possibly leading to other computing tasks being delayed or dropped. There are currently no adequate solutions to the foregoing computer-related, technological problem.

### SUMMARY

Accordingly, in one aspect a device includes at least one processor and storage accessible to the at least one processor. The storage includes instructions executable by the at least one processor to access data and determine, in a first instance and based on the data, a dynamic threshold for invoking a digital assistant. The dynamic threshold is related to a level of confidence for triggering wake up of the digital assistant via a wake-up word. The instructions are also executable to identify, in the first instance, audible input evoking use of the wake-up word and, based on the dynamic threshold being met in the first instance, invoke the digital assistant in response to identifying the audible input. But based on the dynamic threshold not being met in the first instance, the instructions are also executable to decline to invoke the digital assistant in response to identifying the audible input.

In certain example implementations, the dynamic threshold may vary based on whether a first person having a same or phonetically similar name as the wake-up word is identified from the data.

Also in certain example implementations, the dynamic threshold may vary based on whether an identified topic of discussion has a same or phonetically similar pronunciation as the wake-up word. The topic of discussion may be identified from the data, such as from an electronic calendar entry and/or video game data. The video game data may include audio data, video data, subtitle data, and/or game metadata. Additionally, in some examples the topic of discussion may be identified from media streamed over the Internet and/or presented via a television.

Also if desired, in some examples the dynamic threshold may be a first dynamic threshold, the first instance may be during gameplay of a video game, and during a second instance in which gameplay is not identified a second dynamic threshold may be used for invoking the digital assistant. The second dynamic threshold may be lower than the first dynamic threshold.

Still further, in certain example implementations the dynamic threshold may vary based on a distance from a person that provided the audible input to the device. Additionally or alternatively, the dynamic threshold may vary based on a volume level of the audible input and/or a clarity level of the audible input.

Also note that in some examples the device may include the digital assistant and/or a microphone at which the audible input is received.

In another aspect, a method includes accessing one or more types of data and determining, in a first instance and based on the one or more types of data, a dynamic threshold for invoking, via a wake-up word, a digital assistant executing at a device. The method also includes identifying, in the first instance, audible input related to the wake-up word and, based on the dynamic threshold being met in the first instance, invoking the digital assistant in response to identifying the audible input. Based on the dynamic threshold not being met in the first instance, the method also includes declining to invoke the digital assistant in response to identifying the audible input.

Accordingly, in certain examples the dynamic threshold may vary based on identification of a name of a person from a telephone call and/or a voice over internet protocol (VoIP) call that is transpiring in the first instance. In addition to or in lieu of that, the dynamic threshold may be identified from contact information for the person as identified from a contacts list of another individual and/or based on execution of facial recognition to identify a person within a proximity to the device.

Still further, if desired the device may be a first device, and the dynamic threshold may vary based on receipt of one or more signals from a second device different from the first device. The one or more signals may indicate a person having a same or phonetically similar name as the wake-up word.

In still another aspect, at least one computer readable storage medium (CRSM) that is not a transitory signal includes instructions executable by at least one processor to access data and determine, in a first instance and based on the data, a dynamic threshold for invoking a digital assistant via a wake-up word. The instructions are also executable to identify, in the first instance, audible input evoking use of the wake-up word and, based on the dynamic threshold being met in the first instance, invoke the digital assistant in response to identifying the audible input. However, based on the dynamic threshold not being met in the first instance, the instructions are executable to decline to invoke the digital assistant in response to identifying the audible input.

Thus, in certain example embodiments the dynamic threshold may vary based on whether a first person, to be addressed by a second person, has a same or phonetically similar name as the wake-up word as identified from the data. In addition to or in lieu of that, the dynamic threshold may vary based on a topic identified from a voice over internet protocol (VoIP) call and/or a video call. For example, the topic may be identified from an invitation to the VoIP call or video call.

Also in certain example embodiments, the wake-up word may be a first wake-up word, the audible input may be first audible input, and the instructions may be executable to, based on the data, suggest an alternate wake-up word to use to invoke the digital assistant. The instructions may also be executable to receive second audible input evoking use of the alternate wake-up word and invoke the digital assistant in response to identifying the alternate wake-up word.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example illustration of an interaction between two people that does not falsely trigger a digital assistant consistent with present principles;

FIG. 4 illustrates example logic in example flow chart format that may be executed by a device consistent with present principles; and

FIG. 5 shows an example settings graphical user interface (GUI) that may be used to configure one or more settings of a device to operate consistent with present principles.

### DETAILED DESCRIPTION

Among other things, the detailed description below discusses proactive reduction in false wakes of a voice-initiated device through dynamic thresholds to reduce the number of false wakes and deliver a more accurate device and improved user experience.

As an example involving an inbound call or calendar event, suppose a user's daughter Alex is calling him. The user is likely to say, “Hello Alex” and/or use her name throughout the phone call. The phone and the virtual/digital assistant may communicate this and increase the threshold for wake up of the assistant using the word “Alexis” as the likelihood of a false wake up is increased when the phone call is active with Alex the person.

As another example involving VoIP, VoIP attendee detection may be executed. For example, a group of people that meet frequently over VoIP might speak about devices that operate the digital assistant itself, having no intent to actually wake up the associated assistant they are discussing during the discussion. Thus, when the people are speaking over VoIP, the device may increase the threshold for wake up to reduce false wake ups.

As an example involving a video game, suppose a person is playing a game where the main character has a name that is phonetically the same as a wake-up word. The game would therefore broadcast over audio the name of the character, which might otherwise create a false wake up. However, using an Internet of things (IoT) mesh network and/or other network to acquire existing video game data steams like closed caption script, the device may identify as much and increase the threshold for wake-up when the game is being played to decrease false wake ups.

As still another example but using electronic calendar information, suppose a meeting has been scheduled in the calendar that is titled “Election Discussion”. Also suppose the device has been configured with “election” as a known false wake up for a digital assistant having “Alexis” as part of its wake-up. The device executing the digital assistant may therefore harvest this calendar data and increase the wake-up threshold used while the meeting is itself is actually occurring (e.g., based on the arranged time indicated in the calendar transpiring).

Thus, present principles may leverage speech recognition and IoT connectivity. Thresholds can be set by the user and include configurations such as micro location and user profiles. User detection can also be facilitated on site in real time using methods such as facial recognition and/or digital fingerprint. Micro location can be used to proactively filter false wake up words based on micro-location or location source within a space.

Also note that in addition to or in lieu of changing thresholds, an alternative, temporary wake-up word can be suggested by the system for use while the relevant event/instance is still taking place.

As for a function itself that might be executed in response to audible input provided within a threshold time of the wake-up word(s) themselves, examples include providing weather information to a user, sending an email or SMS text message, configuring an IoT device such as turning on a smart light, etc.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

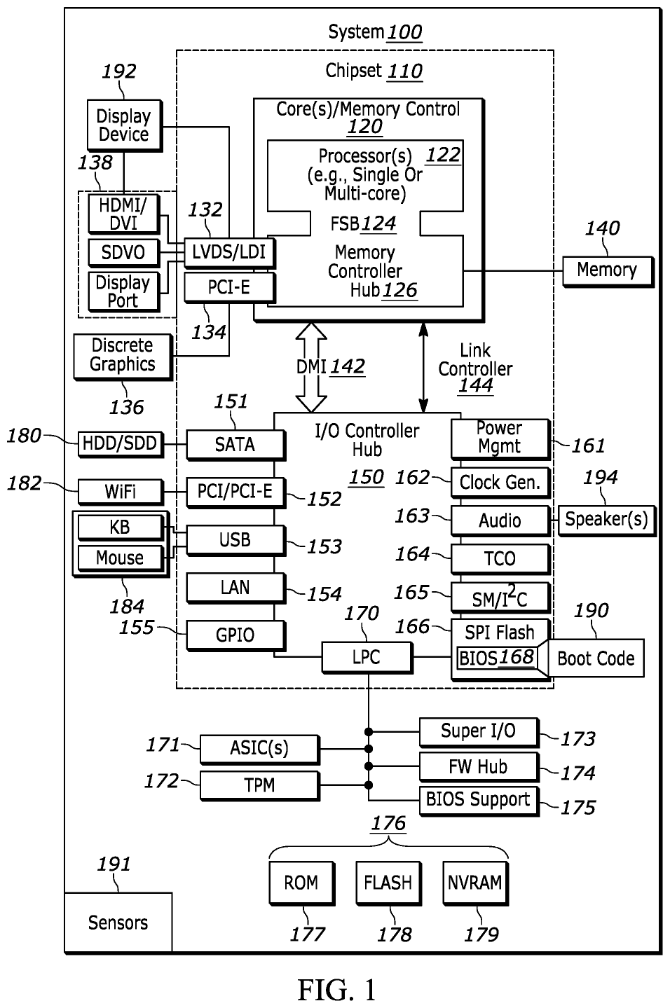

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include one or more sensors 191. For examples, the sensors 191 may include an audio receiver/microphone that provides input from the microphone to the processor 122 based on audio that is detected, such as via a user providing audible input to the microphone to invoke a digital assistant and provide an ensuing command for the assistant to execute. The sensors 191 may also include a camera that gathers one or more images and provides the images and related input to the processor 122, e.g., for facial recognition as described further below. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video.

Additionally or alternatively, the sensors 191 may include location sensors such as a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

Other sensors as also described below may further be included as one of the sensors 191 (e.g., LIDAR).

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122.

It is to be understood that an example client device or other machine/computer may include fewer or more features than shown on the system 100 of FIG. 1. In any case, it is to be understood at least based on the foregoing that the system 100 is configured to undertake present principles.

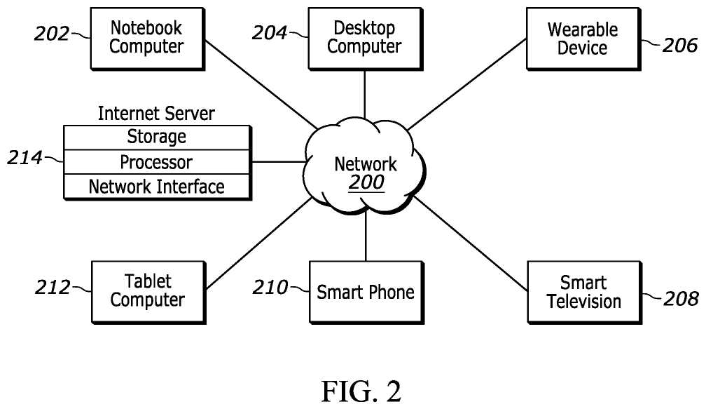

Turning now to FIG. 2, example devices are shown communicating over a network 200 such as the Internet in accordance with present principles (e.g., for remote processing at a server of audible input to a digital assistant as sensed at a local client device). It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

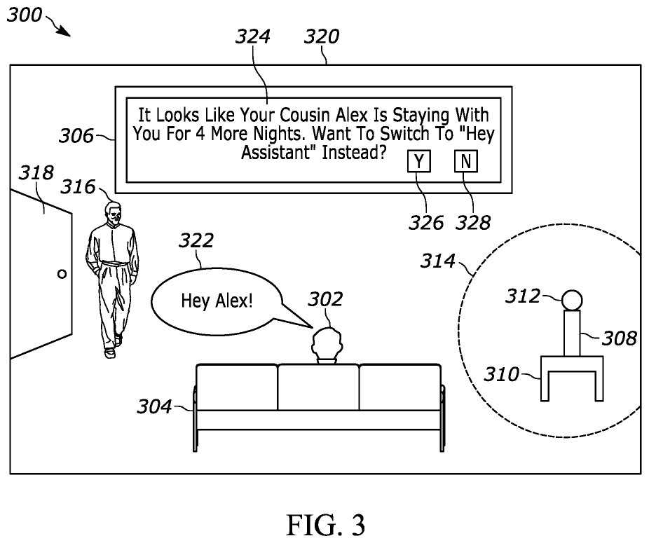

Turning now to FIG. 3, an example illustration 300 is shown consistent with present principles. As may be appreciated from FIG. 3, a first user 302 is sitting on a couch 304 in a living room 320 while watching content presented on a television (TV) 306. As also shown, a stand-alone digital assistant device 308 is sitting on a nearby coffee table 310, with the device 308 including one or more sensors 312 such as a camera and/or microphone.

In some examples, the sensors 312 may include one or more proximity sensors as well, which might include not just the camera but also laser rangefinders/light detection and ranging (LIDAR) modules, infrared (IR) proximity sensors, etc. The proximity sensors may be used to monitor a virtual sphere 314 or other threshold area/micro location within which a person may be located while providing audible input to the digital assistant executing at the device for the digital assistant to then execute one or more functions in conformance with the audible input, regardless of other factors as discussed below which might otherwise lead to the digital assistant declining to execute the function instead. GPS location tracking and/or ultra-wideband (UWB) location tracking of other user-associated client devices may also be used to determine whether the user is within the sphere 314 (by assuming the user and identified device itself are at the same location).

As also shown in FIG. 3, suppose a second user 316 named Alex opens a door 318 and walks into the room 320 in which the user 302, couch 304, TV 306, and device 308 are located. Upon seeing Alex, the user 302 might address the user 316 by audibly exclaiming “Hey Alex!”, as illustrated by speech bubble 322. Assume here that the wake-up word(s) for invoking the digital assistant executing at the device 308 include “Hey Alexis”, and so while monitoring ambient audio/audible input for “Hey Alexis” using its microphone, the device 308 might otherwise be unintentionally triggered by the “Hey Alex” exclamation by the user 302 save for present principles owing to the phonetically same/similar soundings of the two phrases.

However, owing to present principles the user 316 may be identified by the device 308 and a dynamic, heightened threshold for invoking the digital assistant may be used instead, thereby increasing a level of confidence that would be needed in this particular instance for the device 308 to trigger wake up of the digital assistant via the wake-up word(s) to then execute an ensuing audible command. In this way, unintentional triggers of the digital assistant may be reduced or avoided altogether, while at the same time intentional user input to the device 308 to invoke the digital assistant may still be detected and the digital assistant invoked in response.

As for how the user 316 might be identified, in examples where the sensors 312 include a camera and/or where the device 308 has access to another camera feed of the room 320 (e.g., from a stand-alone camera, smartphone camera, etc.), the device 308 may execute facial recognition to identify the face of the user 316 from the camera images when the user is proximate enough to the camera for their face to be detected in the images. The device may then use the facial recognition result to identify a name of the user 316 from prestored profile/facial template information for the user 316. Also note that input from a microphone on the device 308 (or another local device in communication therewith) may also be executed to similarly identify the name of the user 316 from a profile but using voice recognition/identification based on the user 316 speaking upon entering the room.

Additionally or alternatively, wireless signals sent from a personal device such as a smartphone or smart watch borne by the user 316 upon entering the room 320 may be used to lookup profile information for the user 316 and hence the user's name. For example, wireless Bluetooth signals, near-field communication signals, ultra-wideband (UWB) signals, Wi-Fi signals, etc. might be broadcasted by the personal device. Those signals may then be received by a wireless transceiver on the device 308 itself to thus identify the presence of the personal device within a proximity to the device 308 owing to the relatively limited range of those signals, indicating that the associated user is nearby and that a dynamic threshold should be used accordingly so that a phonetically same or similar name for that user as spoken by someone else is not confused as a trigger for the digital assistant. The received signals themselves may indicate identifying information such as device ID, media access control (MAC) address, internet protocol (IP) address, username, etc., any of which may be used to lookup the name of the user from a relational database or profile.

Then once the name of the relevant user has been identified (user 316 in this case), a database preconfigured by a device manufacturer, system administrator, etc. may be accessed as stored locally or remotely from the device 308. This database may indicate various names or other words that might be identified from the sensor input (or other data, such as calendar data or video game data as will be described later) and indicate whether a heightened threshold should be used in instances where the associated person is present or associated word might be used in a context not meant to invoke the digital assistant itself. In some specific examples, the database may even indicate the particular heightened threshold to apply in the respective instance, such as using a threshold level of confidence of 98% that a person meant to invoke the digital assistant while Alex is identified as present (as opposed to using a lower level of confidence of 70% by default as the device might otherwise use when Alex is not present).

Still in reference to FIG. 3, note further than in some example embodiments, the device 308 may be paired with or otherwise configured to communicate with a display such as the TV 306 itself to present a graphical user interface (GUI) 324. The GUI 324 may be presented by the device 308 responsive to determining a heightened threshold to apply in a given instance, which here is based on identification of the user 316 named Alex as being present. As shown in FIG. 3, the GUI 324 may include a text prompt indicating that Alex is a cousin of the user 302 and is residing with the user 302 at the house including the room 320 for four more nights (as may be identified from a calendar entry or other data associated with the user 302 and accessible to the device 308).

As also shown in FIG. 3, the GUI 324 may prompt the user 302 regarding whether the device 308 should monitor for an alternate wake-up word(s) during the time that the user 316 will be staying at the location as an additional way to avoid false positives that might unintentionally trigger the digital assistant. The user 302 may thus use touch input, cursor input, voice input, etc. to either select the yes selector 326 to provide a command to use the alternate wake-up word(s) suggested via the prompt itself (“Hey assistant” in this example), or select the no selector 328 to decline to use the alternate wake-up word(s) and instead continue using the primary wake-up words “Hey Alexis”.

Further note here that in examples where the yes selector 326 is selected and the device 308 is monitoring for the alternate wake-up word(s), the device 308 may configure itself to no longer monitor for audible input evoking use of the wake-up words “Hey Alexis” to trigger the digital assistant in response. However, in other examples the device may still monitor for these primary wake-up words but still use a heightened threshold for determining whether the digital assistant is being invoked based on audible input of the primary wake-up words (while also concurrently monitoring for the alternate wake-up words, possibly with a relatively lower threshold level of confidence during the same instance/period of time).

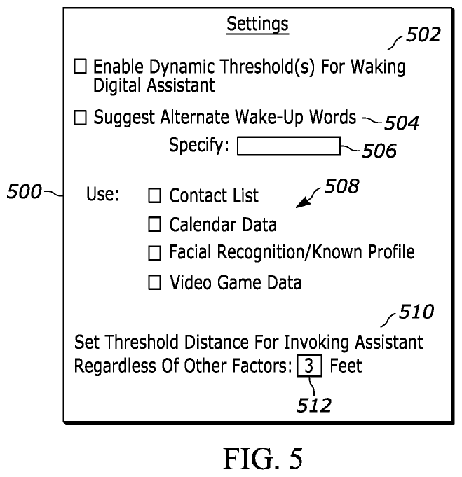

As for the alternate wake-up word(s) themselves, they may be predefined by a manufacturer of the device 308, a system administrator, etc. Additionally or alternatively, they may be preconfigured by the user 302 themselves or another end-user. An example of how an end-user might specify the alternate wake-up word(s) will be discussed later in reference to FIG. 5.

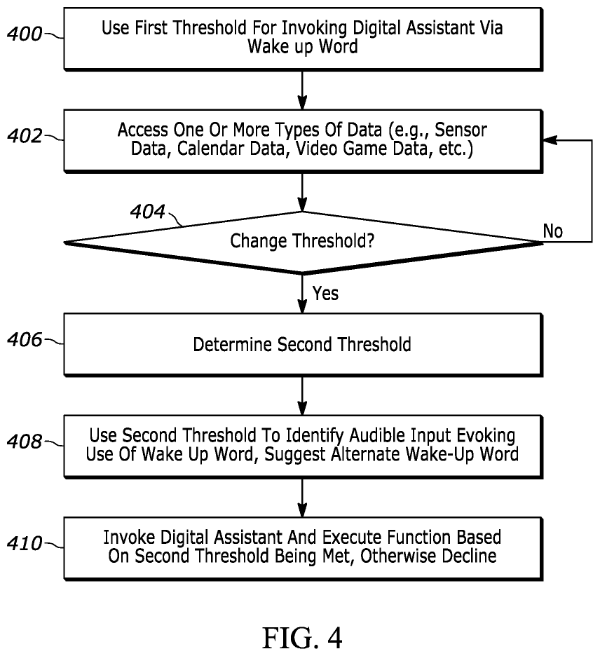

However, FIG. 4 will be described first. This figure shows example logic consistent with present principles that may be executed by a device such as the system 100, the device 308, and/or a remotely-located server in communication with the device 308 in any appropriate combination. Note that while the logic of FIG. 4 is shown in flow chart format, other suitable logic may also be used.

Beginning at block 400, the device may select a first threshold (e.g., default threshold) for determining whether a digital assistant is being invoked via audible input of a wake-up word(s). For example, at block 400 the device may select a first threshold level of confidence in a particular audible input that has been received as invoking the digital assistant. This first threshold may then be used for any audible input potentially invoking the digital assistant that is received during the time the first threshold is selected for use. And note here that the digital assistant itself may be the same as or similar to Amazon's Alexa, Apple's Siri, or Google's Assistant, for example.

From block 400 the logic may then proceed to block 402. At block 402 the device may access one or more types of data, such as receiving sensor data, accessing electronic calendar data from a server, accessing video game data from a server or local video game console, etc. Thereafter the logic may proceed to decision diamond 404 where, based on the accessed data, the device may determine whether the operative threshold for invoking the digital assistant should change from the first threshold to a second, potentially heightened threshold which may be used while a given context or other instance identified from the data is occurring.

A negative determination at diamond 404 may cause the logic to revert back to block 402 (or even block 400) and proceed again therefrom. However, an affirmative determination may instead cause the logic to proceed to block 406 where a second threshold may be determined, e.g., using a database as described above.

From block 406 the logic may then proceed to block 408. At block 408 the device may use the second threshold when analyzing any audible input evoking use of the wake-up word(s) that might be received while the occurrence, context, or other instance identified from the data of block 402 is still ongoing to thus determine whether the digital assistant is actually being invoked based on the audible input (using the heightened second threshold).

Also at block 408, in some examples the device may also suggest an alternate wake-up word, such as through a GUI as described above or even through audio output using a speaker (for which consent from a user may also be audibly received). For example, the device 308 described above might provide an audible prompt reading aloud the text presented on the GUI 324 and then receive an audible “yes” or “no” response from the user via its microphone to configure the device 308 accordingly.

From block 408 the logic of FIG. 4 may then proceed to block 410. At block 410 the device may invoke the digital assistant itself and execute a corresponding function that might be audibly commanded by the user after providing the wake-up word, where the digital assistant would be invoked responsive to the second threshold being met that the audible input that was received was meant to invoke the digital assistant. For example, different inputs may be aggregated to get a confidence level that is at or above the second threshold. Or if the second threshold is not met, the device may instead decline to invoke the digital assistant.

Thus, the device executing the logic of FIG. 4 may access various types of data and determine, in a first instance and based on the data, a dynamic threshold for invoking the digital assistant. The device may then identify, in the first instance, audible input evoking use of the wake-up word and, based on the dynamic threshold being met in the first instance, invoke the digital assistant in response to identifying the audible input. Or if the dynamic threshold is not met in the first instance, the device may decline to invoke the digital assistant in response to identifying the audible input.

Accordingly and to provide additional examples consistent with present principles, the dynamic threshold may vary based on whether a first person having a same or phonetically similar name as the wake-up word is identified from the data (e.g., like in the Alex vs. Alexis example from FIG. 3). Someone speaking the person's name (e.g., to address the person themselves) may therefore have less of a chance of confusing the device into thinking a similar-sounding wake-up word for its digital assistant has been uttered while that person is physically present.

The dynamic threshold may also vary based on whether an identified topic of discussion between people has a same or phonetically similar pronunciation as the wake-up word as another way to avoid confusing the device and unintentionally triggering the digital assistant. The topic of discussion may be identified from the accessed data, where the data may include an electronic calendar entry or email invitation to the relevant meeting/call. Additionally or alternatively, the data may include a voice recognition result to then identify the topic via natural language processing (NLP) and topic segmentation/recognition through the audio of the relevant conversation (as sensed by a microphone). Thus, note here that the topic may be discussed in person or even discussed in a telephone call, VoIP call, video conference, etc. as identified from the audio of the call. In some examples, the identified topic of discussion might even be the digital assistant itself, with the people not meaning to trigger the digital assistant when discussing it.

A topic of discussion might also be identified from video game data provided by a device executing a video game that is currently being played by a user or that is being loaded for play, where the video game data may indicate/include video game character names, names of items from the video game, or other terms associated with the video game that might be confused with a wake-up word for a digital assistant. The video game data itself may include audio data for audio of the video game that can then be analyzed using voice recognition, video data for image frames of the video game that can be analyzed using optical character recognition (OCR) and other software, subtitle/closed captioning data as streamed from the device executing the game, and even game metadata as also provided by the device executing the game. Topic segmentation and recognition may then be executed on these types of game data to identify the topic or other relevant information.

Thus, a first dynamic threshold may be used during gameplay of the video game where a certain keyword or name might be used by the game or spoken by a player, and during another instance in which gameplay is not identified (e.g., before or after the console/device stops executing the video game as reported by the console/device) a second dynamic threshold may be used for invoking the digital assistant that is lower than the first dynamic threshold. In this way, game audio or things that might be spoken by a user in relation to the video game may have less of a chance of being confused by the device as a wake-up word for its digital assistant. Further note that the foregoing may apply not just to video games but also to other types of media that might be played as well, such as TV commercials, motion pictures, and Internet videos whose audio might otherwise unintentionally trigger the digital assistant based on names, keywords, or other topics that are mentioned in the media.

Additionally or alternatively, as already described above the dynamic threshold may also vary based on a distance from a person that provided audible input to the device itself that is executing the digital assistant (e.g., alone or in combination with a remotely-located server). Thus, the closer the user gets incrementally to the device itself, the incrementally lower the threshold may be. In this way, if the user is relatively far away from the device and speaks “Alex” per FIG. 3's example, a higher threshold will be used for the device's confidence that the digital assistant is actually being invoked, whereas lower thresholds will be used the closer the user gets to the device itself since it might be more likely at that point that the user means to invoke the digital assistant. And again note that IR proximity detection may be used, as well as computer vision and images from a camera, GPS, LIDAR, etc.

Still further, in certain implementations the dynamic threshold may also vary based on a volume level of the audible input and/or a clarity level of the audible input evoking use of the wake-up word(s). Thus, incrementally higher thresholds may be used for incrementally lesser volume levels of audible input as sensed by the device's microphone itself, and incrementally higher thresholds may also be used for incrementally less clear audible input (e.g., to the point of being unintelligible or if the audible input includes a relatively high amount of echo). These thresholds may be indicated in a relational database that associates them with respective volume levels/levels of clarity, for example (as may the other thresholds described herein for various contexts or combinations of contexts).

Providing yet another example, further note that the dynamic threshold may vary based on identification of a name of a person participating in a telephone call that is transpiring in a given instance or, similarly, a VoIP call or video call that is transpiring (e.g., as reported by a smartphone of another user with a contacts list indicating the identity of one or more other people on the call). Also note that in addition to or in lieu of using a contacts list to identify one or more participants to the call, calendar or meeting invite information may also be accessed to determine the participants, and/or voice ID may be executed on audio of the call itself to identify the user by their voice print. Then if a participant with a certain name is addressed during the call that could be confused with the relevant wake-up word itself, a heightened threshold may be used. And again note that various names (and/or topics) may be associated in a relational database that is accessed with different respective thresholds to apply if a person with that name is in on a call, video conference, etc. (and/or if a participant speaks the relevant topic).

Further note consistent with present principles that any one or more of the foregoing instances may transpire concurrently and that in such as case, different combinations of these instances occurring may result in a different dynamic threshold being used. The different combinations and corresponding dynamic threshold to use may also be indicated in a relational database accessible to the relevant device.

Also note that in any of the foregoing instances, alternate wake-up words may additionally or alternatively be used as well. Thus, in any of those instances, the device may, based on whatever data is accessed, suggest an alternate wake-up word to use to invoke the digital assistant, receive audible input evoking use of the alternate wake-up word, and invoke the digital assistant in response to identifying the alternate wake-up word.

As an additional example using the video game example again, the device may present a prompt like the GUI 324 but that indicates that the device has identified that a certain user just bought or installed a new video game (e.g., as determined from purchase or install data) that frequently uses a word that is the same as or phonetically similar to a wake-up word. The device may also ask if the user wishes to use an alternate wake-up word during times the device identifies the game as being played.

Now in reference to FIG. 5, it shows an example settings GUI 500 that may be presented on a display to configure one or more settings of a device to operate consistent with present principles. For example, the GUI 500 may be presented on a client device display that might be undertaking the logic of FIG. 4 and other functions described above.

The settings GUI 500 may be presented to set or enable one or more settings of the device/digital assistant itself to operate consistent with present principles. The GUI 500 may be reached by navigating a main settings menu of the device or its operating system, or navigating a menu of a dedicated digital assistant application. Also note that in the example shown, each option discussed below may be selected by directing touch, cursor, or other input to the respective check box adjacent to the respective option.

As shown in FIG. 5, the GUI 500 may include an option 502 that may be selectable a single time to set or enable the device, system, software, etc. to undertake present principles for multiple future instances, such as executing the functions described above and/or executing the logic of FIG. 4 to change a dynamic threshold that is used for different instances where a false triggering of the digital assistant might occur.

The GUI 500 may also include an option 504 that may be selectable to set or enable the device to suggest and monitor for alternate wake-up words during identified instances where a primary wake-up word might get confused with something else. If desired, the end-user may even enter text into text entry box 506 using a hard or soft keyboard to specify the alternate wake-up word(s) to use.

Still further, if desired the GUI 500 may further include one or more options 508 that are respectively selectable to select one or more types of data to access/use consistent with present principles. As shown in FIG. 5, these types of data may include contact list data, calendar data, facial recognition and known profile/facial template data, and video game data. However, further note that any of the types disclosed here may be listed on the GUI 500 as a respective option 508 and that only four are shown for simplicity.

Additionally, in some examples the GUI 500 may also include a setting 510 at which the end-user may establish a threshold distance (or radius) from the device within which a user that potentially invokes the digital assistant will be considered as in fact intentionally invoking the digital assistant (e.g., regardless of other factors such as another person being present with a similar-sounding name to a wake-up word). So, for example, the threshold distance may be used to establish the boundaries of the sphere 314 described above. As for the setting 510 itself, note that the end-user may direct input to number entry box 512 to establish the threshold distance as a particular number of feet, though another increment of length may be selected from a drop-down box or other GUI element if desired.

It may now be appreciated that present principles provide for an improved computer-based user interface that increases the functionality and ease of use of the devices disclosed herein while also improving device processing and reducing RAM and power consumption that might otherwise occur based on false positive triggers of a digital assistant. The disclosed concepts are rooted thus in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor; and
storage accessible to the at least one processor and comprising instructions executable by the at least one processor to:
access data;
determine, in a first instance and based on the data, a dynamic threshold for invoking a digital assistant, the dynamic threshold related to a level of confidence for triggering wake up of the digital assistant via a wake-up word;
identify, in the first instance, audible input evoking use of the wake-up word;
based on the dynamic threshold being met in the first instance, invoke the digital assistant in response to identifying the audible input; and
based on the dynamic threshold not being met in the first instance, decline to invoke the digital assistant in response to identifying the audible input.

2. The device of claim 1, wherein the dynamic threshold varies based on whether a first person having a same or phonetically similar name as the wake-up word is identified from the data.

3. The device of claim 1, wherein the dynamic threshold varies based on whether an identified topic of discussion has a same or phonetically similar pronunciation as the wake-up word, the topic of discussion being identified from the data.

4. The device of claim 3, wherein the identified topic of discussion is identified from an electronic calendar entry.

5. The device of claim 3, wherein the identified topic of discussion is identified from video game data, the video game data comprising one or more of: audio data, video data, subtitle data, game metadata.

6. The device of claim 3, wherein the dynamic threshold is a first dynamic threshold, wherein the first instance is during gameplay of the video game, and wherein during a second instance in which gameplay is not identified a second dynamic threshold is used for invoking the digital assistant, the second dynamic threshold being lower than the first dynamic threshold.

7. The device of claim 3, wherein the identified topic of discussion is identified from media one or more of: streamed over the Internet, presented via a television.

8. The device of claim 1, wherein the dynamic threshold varies based on a distance from a person that provided the audible input to the device.

9. The device of claim 1, wherein the dynamic threshold varies based on one or more of: a volume level of the audible input, a clarity level of the audible input.

10. The device of claim 1, comprising a microphone at which the audible input is received.

11. A method, comprising:
accessing one or more types of data;
determining, in a first instance and based on the one or more types of data, a dynamic threshold for invoking, via a wake-up word, a digital assistant executing at a device;
identifying, in the first instance, audible input related to the wake-up word;
based on the dynamic threshold being met in the first instance, invoking the digital assistant in response to identifying the audible input; and
based on the dynamic threshold not being met in the first instance, declining to invoke the digital assistant in response to identifying the audible input.

12. The method of claim 11, wherein the dynamic threshold varies based on identification of a name of a person from one or more of: a telephone call that is transpiring in the first instance, a voice over internet protocol (Volt′) call that is transpiring in the first instance.

13. The method of claim 12, wherein the dynamic threshold is identified from contact information for the person as identified from a contacts list of another individual.

14. The method of claim 11, wherein the dynamic threshold varies based on execution of facial recognition to identify a person within a proximity to the device.

15. The method of claim 11, wherein the device is a first device, and wherein the dynamic threshold varies based on receipt of one or more signals from a second device different from the first device, the one or more signals indicating a person having a same or phonetically similar name as the wake-up word.

16. At least one computer readable storage medium (CRSM) that is not a transitory signal, the at least one computer readable storage medium comprising instructions executable by at least one processor to:
access data;
determine, in a first instance and based on the data, a dynamic threshold for invoking a digital assistant via a wake-up word;
identify, in the first instance, audible input evoking use of the wake-up word;
based on the dynamic threshold being met in the first instance, invoke the digital assistant in response to identifying the audible input; and
based on the dynamic threshold not being met in the first instance, decline to invoke the digital assistant in response to identifying the audible input.

17. The CRSM of claim 16, wherein the dynamic threshold varies based on whether a first person, to be addressed by a second person, has a same or phonetically similar name as the wake-up word as identified from the data.

18. The CRSM of claim 16, wherein the dynamic threshold varies based on a topic identified from one or more of: a voice over internet protocol (Von′) call, a video call.

19. The CRSM of claim 18, wherein the topic is identified from an invitation to the VoIP call or video call.

20. The CRSM of claim 17, wherein the wake-up word is a first wake-up word, wherein the audible input is first audible input, and wherein the instructions are executable to:
based on the data, suggest an alternate wake-up word to use to invoke the digital assistant;
receive second audible input evoking use of the alternate wake-up word; and
invoke the digital assistant in response to identifying the alternate wake-up word.
